(19) United States
(12) Patent Application Publication
(10) Pub. No.: US 2025/0058495 A1
(43) Pub. Date: Feb. 20, 2025

(54) System and Method for Enhancing Detail and Printing High-Resolution Imagery on 3D Printed Concrete Surfaces

(71) Applicant: justin D'Angelo, Palm City, FL (US)

(72) Inventors: Justin Arnold D'Angelo, Palm City, FL (US); Keith Hill, Wilbraham, MA (US); Cody Gatts, West Palm Beach, FL (US)

(21) Appl. No.: 18/450,063

(22) Filed: Aug. 15, 2023

(51) Int. Cl. B28B 11/00; B28B 1/00; B28B 11/08; B33Y 10/00; B33Y 30/00; B33Y 40/20

(52) U.S. Cl. CPC B28B 11/001; B28B 1/001; B28B 11/0845; B33Y 10/00; B33Y 30/00; B33Y 40/20

(57) ABSTRACT

The invention presents a method and system for enhancing the aesthetics and functionality of 3D printed concrete objects. It involves an inkjet printing processes to improve the quality of the printed concrete objects. The method involves using a robot-mounted inkjet printhead, directed by a computer-controlled mechanism, to apply high-resolution imagery, colors, or patterns onto the object's surface while following the non-uniform contours of the object, including 3D printed ridges. The applied ink is then allowed to cure and bond with the object's surface. The invention enhances the detail and enables the application of high-resolution images onto 3D printed concrete structures.

### FIELD OF INVENTION

This invention relates to the field of three-dimensional (3D) printing technology, particularly to an enhanced method for detailing of 3D printed concrete structures, incorporating both milling and inkjet imaging applications.

### BACKGROUND

Three-dimensional (3D) printing technology has become widely utilized across a variety of industries, including the construction industry. Concrete 3D printing has emerged as a versatile and cost-effective method for the construction of intricate structures and objects. In the typical process, a concrete material is extruded in a layer-by-layer fashion by a mechanized application such as a robotic arm or gantry system, forming a three-dimensional object.

Despite the advances in this technology, there are significant limitations associated with the post-processing of 3D printed concrete objects. One common issue is the visible layer lines left on the object's surface after the 3D printing process, which adversely impact the aesthetic quality and precision of the final product.

Furthermore, the application of color, designs, and images onto the surfaces of 3D printed concrete objects presents a distinct set of challenges. Due to the rough and uneven nature of these surfaces, traditional methods such as integral pigments, spray paints, or roller-based dyes have proven to be impractical for creating high-resolution, detailed designs or branding elements. The irregular surfaces and varying shapes of the objects further complicate the application process, often resulting in uneven and unattractive outcomes.

In response to the demand for improved aesthetics in 3D printed concrete structures, there has been a motivation to develop post-processing techniques that can eliminate the visibility of layer lines and enable the application of high-quality images directly onto the surfaces of the printed objects.

However, previous attempts have not fully addressed these issues, leaving a significant need for a post-processing system capable of refining and enhancing the detail of 3D printed concrete structures and efficiently applying high-resolution imagery directly onto their surfaces.

The limitations and drawbacks of existing technologies underscore the need for the current invention, which aims to provide a comprehensive and effective solution for post-processing of 3D printed concrete structures.

It is within this context that the present invention is provided.

### SUMMARY

The present invention addresses the limitations and drawbacks of existing technology by providing a novel method and system for enhancing the detail and printing images onto 3D printed concrete objects. The invention utilizes computer controlled inkjet printing techniques to improve the aesthetic quality and functionality of these objects.

In one embodiment, the method involves directing an inkjet printhead to the surface of the 3D printed object using a computer-controlled mechanism such as a robotic arm or a gantry system. The inkjet printhead maintains a consistent distance from the object during the printing process to ensure uniform application of ink, thereby enabling high-resolution imagery, colors, or patterns on the surface of the 3D printed object. The ink is then allowed to cure and bond with the surface of the object.

In another embodiment, the method further involves the pre-printing process of extruding a concrete material layer by layer to form a 3D object, and letting the object cure. Following this, the 3D object is milled with a robot-mounted CNC bit or carving tool to eliminate visible layer lines.

In another embodiment, the invention provides a system that comprises a 3D printing mechanism for forming the 3D object, a robot-mounted CNC bit or carving tool for post-curing milling, a computer-controlled mechanism for directing an inkjet printhead, and a curing mechanism for allowing the ink to bond with the object. The inkjet printhead is capable of extruding ink onto the surface of the object, enabling high-quality image application.

The invention may also include a CAD file reader for reading a CAD file of the 3D object, and a code translator for translating the CAD file into a print path in the form of robot code.

In sum, this invention provides a comprehensive solution for post-processing of 3D printed concrete structures, enhancing their detail and enabling the application of high-resolution imagery directly onto their surfaces. This solution improves upon the existing technology by ensuring consistent image quality and increasing the versatility of 3D printed concrete objects.

### BRIEF DESCRIPTION OF THE DRAWINGS

Various embodiments of the invention are disclosed in the following detailed description and accompanying drawings.

FIG. 1 is a profile view illustrating the inventive inkjet printing process, where an inkjet printhead applies ink onto a 3D printed concrete surface characterized by print ridges.

FIG. 2 is a zoomed-out profile view showing the inkjet printhead mounted to a robotic arm. The robotic arm maintains a consistent distance between the printhead and the non-uniform surface of a 3D printed concrete object, facilitating the application of a high-fidelity design onto the surface.

FIG. 3 is a flowchart representing the step-by-step process of the invention, detailing the sequence from the initial extrusion of the concrete material to the final curing of the inked design on the 3D printed object.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a method and system for enhancing the aesthetics and functionality of 3D printed concrete objects by implementing a unique combination of milling and inkjet printing processes.

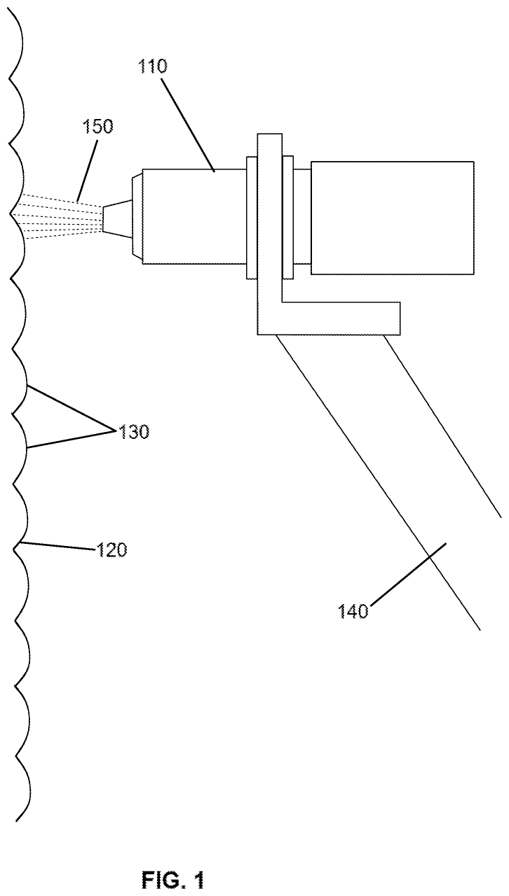

In accordance with one embodiment of the present invention, a 3D printing process is initiated wherein a concrete material is extruded layer by layer to form a three-dimensional (3D) object. As shown in FIG. 1, this process is typically controlled by a robotic arm or a similar mechanized application. The extrusion process continues until the desired 3D object is formed. The 3D object is then allowed to cure, thereby solidifying its form and making it ready for further processing.

Following the curing process, the 3D object undergoes a post-curing milling operation. This operation is performed using a robot-mounted CNC bit or a carving tool. This milling process is used to remove visible layer lines on the object's surface, effectively improving the object's overall aesthetic appeal and detail.

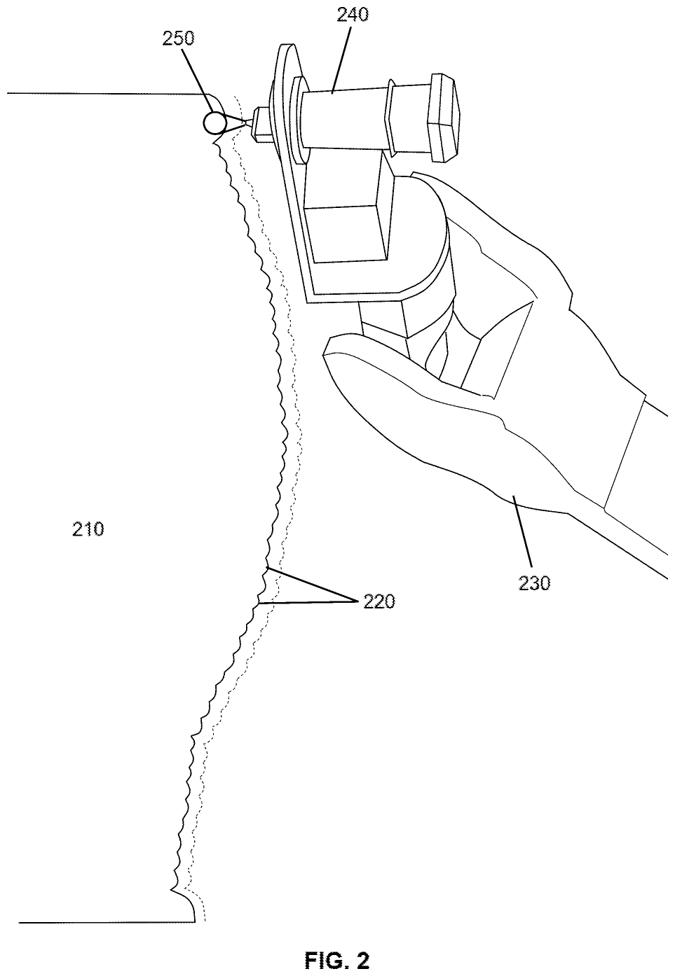

In accordance with a further embodiment of the present invention, a computer-controlled mechanism, such as a robotic arm or a gantry system, directs an inkjet printhead towards the surface of the 3D printed object. As shown in FIG. 2, the inkjet printhead maintains a consistent distance from the surface of the 3D printed object. This consistent distance is important to ensure the uniform application of ink on the object's surface.

The inkjet printhead, which may be a standard Epson DX7 printhead or similar, then extrudes ink onto the surface of the 3D printed object. The applied ink may form high-resolution imagery, colors, or patterns, offering a wide range of design possibilities. The ink is then left to cure and bond with the surface of the 3D printed object.

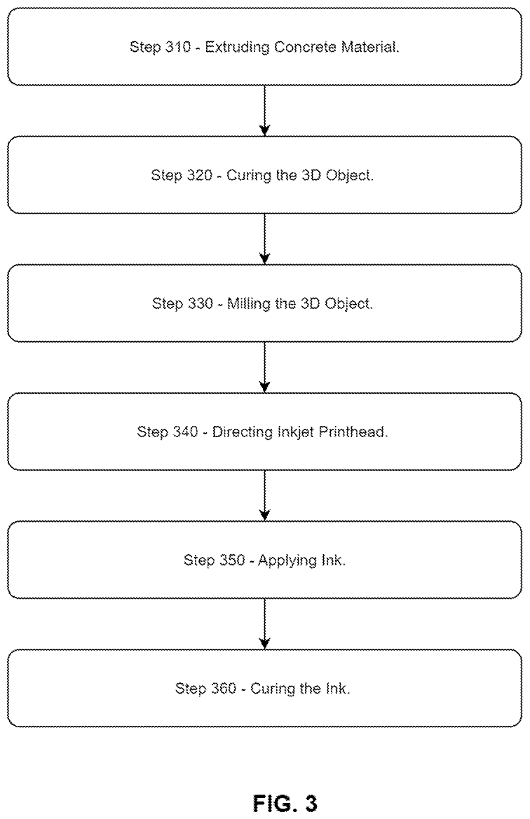

Furthermore, the computer-controlled mechanism directing the inkjet printhead can read a CAD file of the 3D object. The CAD file is translated into a print path in the form of robot code, as shown in FIG. 3. This print path ensures that the printhead follows the contours of the 3D object accurately, enabling a high level of detail in the applied images and designs.

FIG. 1 is a profile view of the inventive system applying an inked design to a three-dimensional (3D) printed concrete surface. The figure illustrates how the inkjet printhead (110) effectively applies ink to the concrete surface (120) in the presence of print ridges (130).

The inkjet printhead (110) is shown attached to a mechanized application, such as a robotic arm (140), which maintains a consistent distance from the uneven concrete surface (120). This consistent distance is crucial to achieve high-resolution imagery on the concrete surface (120).

The concrete surface (120) is characterized by print ridges (130) that are a result of the layer-by-layer 3D printing process. These print ridges (130) create unevenness and irregularities on the surface (120), which typically pose a challenge for applying designs. However, the present invention successfully addresses this challenge by employing a specific application technique.

The inkjet printhead (110) angles the ink spray (150) such that it fills the voids between the print ridges (130). By doing so, the inkjet printhead (110) effectively accounts for the uneven surface and enables the application of high-fidelity designs onto the concrete surface (120).

The inventive method ensures a consistent image quality, thereby increasing the aesthetic appeal and functionality of the 3D printed concrete object.

FIG. 2 provides a zoomed-out profile view of the inventive inkjet process depicted in FIG. 1, emphasizing the role of the robotic arm in maintaining a consistent distance between the inkjet printhead and the 3D printed concrete surface.

The figure illustrates a 3D printed concrete object (210) with a curved and non-uniform shape, indicative of the non-regular path followed by the 3D printer during the layer-by-layer construction process. The object's surface (210) is characterized by its irregularity and unevenness, reflected in the visible print ridges (220).

Mounted to a robotic arm (230) is the inkjet printhead (240). The robotic arm (230) is designed to move with great flexibility and precision, crucial for the successful operation of the inkjet process on non-uniform surfaces.

As shown, the robotic arm (230) closely follows the contours of the 3D printed object (210), maintaining a consistent distance between the inkjet printhead (240) and the concrete surface (210). This consistent distance is paramount to the application of a high-fidelity, evenly spread inked design (250) onto the surface (210).

Despite the surface irregularities (220) and non-uniform shape of the object (210), FIG. 2 illustrates how the robotic arm (230) adeptly manages to maintain the printhead (240) at a constant distance from the object's surface (210), facilitating a precise application of the ink (250).

FIG. 3 presents a flowchart outlining the step-by-step process of the inventive method for enhancing detail and printing images on 3D printed concrete objects.

The process starts with Step 310: “Extruding Concrete Material”. This step involves the formation of a 3D object by extruding a concrete material layer by layer. The extrusion process is typically controlled by a robotic arm or a similar mechanized application.

Upon completion of the extrusion, the process moves to Step 320: “Curing the 3D Object”. In this step, the 3D object is left to cure, solidifying its form and preparing it for further processing

Once the 3D object has cured, the process advances to Step 330: “Milling the 3D Object”. During this step, the 3D object undergoes a milling operation using a robot-mounted CNC bit or carving tool to remove the visible layer lines and improve the object's overall aesthetic appeal and detail.

The next step in the process is Step 340: “Directing Inkjet Printhead”. Here, a computer-controlled mechanism, such as a robotic arm or a gantry system, directs an inkjet printhead to the surface of the 3D printed object, maintaining a consistent distance to ensure uniform application of ink.

Step 350: “Applying Ink”, involves the inkjet printhead extruding ink onto the surface of the 3D printed object, forming high-resolution imagery, colors, or patterns.

Finally, the process concludes with Step 360: “Curing the Ink”. In this final step, the applied ink is left to cure and bond with the surface of the 3D printed object, effectively completing the enhancement of the 3D printed concrete object.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for enhancing the detail and printing images on a 3D printed concrete object, comprising:
directing an inkjet printhead to the surface of the 3D printed object by a computer-controlled mechanism;
maintaining a consistent distance between the inkjet printhead and the 3D printed object during the printing process;
extruding ink onto the surface of the 3D printed object using the inkjet printhead;
allowing the ink to cure and bond with the surface of the 3D printed object.

2. The method of claim 1, further comprising the steps of:
extruding a concrete material layer by layer to form a 3D object;
letting the 3D object cure; and
milling the 3D object with a robot-mounted CNC bit or carving tool post-curing to eliminate the visible layer lines.

3. The method of claim 1, wherein the computer-controlled mechanism is a robotic arm.

4. The method of claim 1, wherein the computer-controlled mechanism is a gantry system.

5. The method of claim 1, wherein the inkjet printhead is a standard Epson DX7 printhead.

6. The method of claim 1, further comprising:
reading a CAD file of the 3D object;
translating the CAD file into a print path in the form of robot code;
directing the inkjet printhead based on the print path.

7. The method of claim 1, wherein the printed images include high-resolution imagery, colors, or patterns.

8. A system for enhancing the detail and printing images on a 3D printed concrete object, comprising:
a computer-controlled mechanism for directing an inkjet printhead to the surface of the 3D printed object;
an inkjet printhead for extruding ink onto the surface of the 3D printed object;
a curing mechanism for allowing the ink to cure and bond with the surface of the 3D printed object.

9. The system of claim 8, further comprising:
a 3D printing mechanism for extruding a concrete material layer by layer to form a 3D object;
a robot-mounted CNC bit or carving tool for milling the 3D object post-curing to eliminate the visible layer lines;

10. The system of claim 8, wherein the computer-controlled mechanism is a robotic arm.

11. The system of claim 8, wherein the computer-controlled mechanism is a gantry system.

12. The system of claim 8, wherein the inkjet printhead is a standard Epson DX7 printhead.

13. The system of claim 8, further comprising:
a CAD file reader for reading a CAD file of the 3D object;
a code translator for translating the CAD file into a print path in the form of robot code.

14. The system of claim 8, wherein the printed images include high-resolution imagery, colors, or patterns.
